(19) United States
(12) Patent Application Publication
(10) Pub. No.: US 2012/0047350 A1
(43) Pub. Date: Feb. 23, 2012

(54) CONTROLLING SIMD PARALLEL PROCESSORS

(76) Inventors: John Lancaster, Buckinghamshire (GB); Martin Whitaker, Buckinghamshire (GB)

(21) Appl. No.: 13/318,404

(22) PCT Filed: May 4, 2010
(86) PCT No.: PCT/GB10/50733

§ 371 Date: Nov. 1, 2011

(30) Foreign Application Priority Data
May 1, 2009 (GB) 0907559.9

(51) Int. Cl. G06F 15/80; G06F 9/02

(52) U.S. Cl. 712/30; 712/E09.002

(57) ABSTRACT

A processing apparatus for processing source code comprising a plurality of single line instructions to implement a desired processing function is described. The processing apparatus comprises:

i) a string-based non-associative multiple—SIMD (Single Instruction Multiple Data) parallel processor arranged to process a plurality of different instruction streams in parallel, the processor including: a plurality of data processing elements connected sequentially in a string topology and organised to operate in a multiple—SIMD configuration, the data processing elements being arranged to be selectively and independently activated to take part in processing operations, and a plurality of SIMD controllers, each connectable to a group of selected data processing elements of the plurality of data processing elements for processing a specific instruction stream, each group being defined dynamically during run-time by a single line instruction provided in the source code, and

ii) a compiler for verifying and converting the plurality of the single line instructions into an executable set of commands for the parallel processor, wherein the processing apparatus is arranged to process each single line instruction which specifies an operation and an active group of selected data processing elements for each SIMD controller that is to take part in the operation.

### FIELD OF THE INVENTION

The present invention relates to a novel way of controlling a new type of SIM-SIMD parallel data processor described below. The control commands allow direct manipulation of the operation of the parallel processor and are embodied in a programming language which is able to express, for example complex video signal processing, tasks very concisely but also expressively. This new way of providing for user control of the SIM-SIMD processor has many benefits including faster compilation and more concise control command expression.

### BACKGROUND

Control of prior art SIMD parallel processors has traditionally been using a set of user-defined processing instructions which are executed sequentially by the processor. In view of this, traditional programming languages such as C++ have been used extensively in engineering for programming the operation of associative and non-associative processing architectures. The problem with these types of languages are that they are general purpose and have to be compiled into a specific instruction set which can be implemented on the processing architecture. This compiled executable code is still relatively slow as known instructions sets are designed to be used to configure general purpose processors which requires a greater number of different types of instruction to be available. This, in turn, slows down the speed of processing of the run-time application (sequence of control commands) on the processor.

Reduced Instruction Sets (RISC) are known which are reduced both in size and complexity of addressing modes, in order to enable easier implementation, greater instruction level parallelism, and more efficient compilers. However, while RISCs are easier to implement for a compiler, they are typically limited to a specific fixed single processor architecture and are not easy for an inexperienced programmer to use to express the required control of the processor. Processor instructions are typically not intuitive to the programmer as they are optimised for performance and not intelligibility.

A new type of processing architecture, described in our co-pending International patent applications published as WO2009/141654 (compression engine architecture) and WO 2009/141612 (Data Processing Element) both of which are incorporated herein by reference as if fully set forth herein, has been developed which reflects the new SIM-SIMD processor architecture previously mentioned. The essence of this structure is that multiple instruction units are provided for working on different parts of a problem and these different instruction units whilst at any given moment in time work on non-overlapping processing units do need over the course of execution of multiple instructions to work on the same data set, namely they need to have access to overlapping parts of the same data set.

There have been difficulties in trying to control this new type of processing architecture using general purpose programming languages as they all require a great deal of special constructs to be built to try to exploit specific attributes of the processing architecture, for example Unified C. Dedicated programming languages, such as Parallel Fortran, are also general purpose in one sense as they are generic to all parallel processors, and so in theory is available to be used. Whilst use of these general purpose programming languages is straight-forward, their compilation and associated code store are not optimised to the specific SIMD architecture and so the source code is inefficient and not optimized.

### SUMMARY OF THE DISCLOSURE

The present disclosure provides an improved way of controlling the SIM-SIMD architecture which is both efficient in compilation and easy for the inexperienced user to use for specifying the required instructions which a parallel processor, having a SIM-SIMD architecture, has to implement.

According to one aspect of the present disclosure there is provided a processing apparatus for processing source code comprising a plurality of single line instructions to implement a desired processing function, the processing apparatus comprising:

i) a string-based non-associative multiple—SIMD (Single Instruction Multiple Data) parallel processor arranged to process a plurality of different instruction streams in parallel, the processor including: a plurality of data processing elements connected sequentially in a string topology and organised to operate in a multiple—SIMD configuration, the data processing elements being arranged to be selectively and independently activated to take part in processing operations, and a plurality of SIMD controllers, each connectable to a group of selected data processing elements of the plurality of data processing elements for processing a specific instruction stream, each group being defined dynamically during run-time by a single line instruction provided in the source code, and

ii) a compiler for verifying and converting the plurality of the single line instructions into an executable set of commands for the parallel processor, wherein the processing apparatus is arranged to process each single line instruction which specifies an operation and an active group of selected data processing elements for each SIMD controller that is to take part in the operation.

The term ‘single line instruction’ means an instruction in source code which comprises operands and an operator and which, within a single line of source code, completely defines how the operation (or rule) is to be carried out on the parallel processor. Thus high level commands and procedures can be reflected in a single line of source code rather than a whole block of source code which improves readability and compiler efficiency.

Advantageously, the present data processing architecture permits the control of the number of processing elements activated (and so deactivated) to be handled at the instruction set level. This means that only the bare minimum number of processing elements required for each and every processing task need be invoked. This can significantly minimise energy consumption of the processing architecture as the deactivated processing elements are not wastefully kept activated during processing tasks for which they are not required. This arrangement also permits groups of processing elements to be defined and to be assigned to different tasks maximising the utility of the parallel processor as a whole. Accordingly, sets of processing elements can be assigned to work on processing tasks concurrently in a highly dynamic way.

For example, if there are eight operands to sum using a parallel processor: A, B, C, D, E, F, G, H, the instruction set may specify that for a first processing step, four processing elements be enabled: PA PB PC PD, and that PA is to sum operands A and B (result=AB), PB is to sum operands C and D (result=CD), PC is to sum operands E and F (result=EF), and PD is to sum operands G and H (result=GH). In the second clock cycle, only processing elements PA and PB need remain enabled to sum the results: PA summing AB and CD (result=ABCD) and PB summing EF and GH (result=EFGH). In the last clock cycle, only one processing element, PA, need be enabled for summing ABCD and EFGH. As will be appreciated, this leads to a very efficient way (three clock cycles) in which the summation of the eight operands is achieved. Furthermore, by way of example, during the last processing step, the processing elements PB, PC and PD not being utilised for the operand summing task can either be deactivated—thereby saving energy, or they can be allocated to another task—thereby maximising the efficiency and utility of the data processing architecture.

The single line instruction may comprises a qualifier statement and the processing apparatus is arranged to process a single line instruction to activate the group of selected data processing elements for a given operation, on condition of the qualifier statement being true.

The ability to qualify the activation of parts of an instruction is highly advantageous in that it reduces the need for unnecessary ‘if then else’ constructs in source code, reduces the size of the source code and therefore optimises compiler performance. Furthermore, it enables the non-associative parallel processor to perform associative operations without the loss of speed overhead associated with traditional associative parallel processors.

Each of the processing elements of the parallel processor may advantageously comprise: an Arithmetic Logic Unit (ALU); a set of Flags describing the result of the last operation performed by the ALU and a TAG register indicating least significant bits of the last operation performed by the ALU, and the qualifier statement in the single line instruction may comprise either a specific condition of a Flag of an Arithmetic Logic Unit result or a Tag Value of a TAG register. This advantageously enables the instruction to specify a specific condition of a previous operation within an instruction thereby giving the instruction a high degree for resolution in determining the conditions upon which to carry out an operation. This high degree of resolution is achieved efficiently within a single line instruction structure which optimises compiler efficiency without making the source code more difficult to understand.

The single line instruction may comprise a subset definition statement defining a non-overlapping subset of the group of active data processing elements and the processing apparatus may be arranged to process the single line instruction to activate the subset of the group of active data processing elements for a given operation. Thus advantageously within an instruction in which a group has been defined, subgroups may be further defined to implement specific parts of the instruction. This nesting of group and sub group activation removes the need for additional lines of source code defining subgroups and repeating the instruction and makes the source code compile more efficiently whilst at the same time does not detract substantially from the readability of the source code.

The single line instruction comprises a subset definition statement for defining the subset of the group of selected data processing elements, the subset definition being expressed as a pattern which has less elements than the available number of data processing elements in the group and the processing apparatus is arranged to define the subset by repeating the pattern until each of the data processing elements in the group has applied to it an active or inactive definition. Thus in the case where there is any form of repetition in the definition of an instruction is accommodated without the need for extra lines of source code defining loops or for specifying entire lengthy sets of identifiers which can in some cases be of the order of thousands. Utilising the pattern repetition is a very powerful and efficient way of expressing these values and has even greater benefit with larger subset definitions.

The single line instruction advantageously comprises a group definition for defining the group of selected data processing elements, the group definition being expressed as a pattern which has less elements than the total available number of data processing elements and the processing apparatus is arranged to define the group by repeating the pattern until each of the possible data processing elements has applied to it an active or inactive definition. This way of defining a group of processing elements has the same advantages as have been expressed above in relation to subgroups.

The single line instruction may comprise at least one vector operand field relating to the operation to be performed, and the processing apparatus may be arranged to process the vector operand field to modify the operand prior to execution of the operation thereon. The ability to modify vector operands prior to operation execution is highly advantageous. This is because in many cases the ability to carry out a simple operation on an operand prior to its use within an instruction execution enables the desired result to be obtained more quickly without recourse to the assigned results register. More specifically, the alternative of sequential execution of two operations requires the results of the first operation to be stored in the assigned results register prior to execution of the second operation, whereas these extra storage steps are avoided by the present feature of the present invention. It is also possible to specify within the instruction to modify the result, post execution operation. Again this feature improves efficiency of the compiler.

The single line instruction may advantageously specify within its operand definition, a location remote to the processing element and the processing apparatus may be arranged to process the operand definition to fetch a vector operand from the remote location prior to execution of the operation thereon. These types of commands include GET commands which advantageously enable vector operands to be obtained from neighbouring processing elements relatively quickly or further processing elements located further away in multiple clock cycles (but within a single command). The fact that the operand definition includes this active data fetching command makes the source code more compact and more efficient for compilation purposes. However, the single line instruction still is easy to understand even by inexperienced readers as it retains a high level of readability.

The processing apparatus may be arranged to modify the operand by carrying out one of the operations selected from the group comprising a shift operation, a count leading zeros operation, a complement operation and an absolute value calculation operation. These are types of simple instructions which can be used as a modifier instruction to an operand which can be carried out efficiently without complicating the parallel processor architecture.

The single line instruction may comprise at least one fetch map variable in a vector operand field, the fetch map variable specifying a set of fetch distances for obtaining data for the operation to be performed by the active data processing elements, wherein each of the active data processing elements has a corresponding fetch distance specified in the fetch map variable. The advantages of this feature have been described in the preceding paragraph.

The processing elements are preferably arranged in a sequential string topology and the fetch variable specifies an offset denoting that a given processing element is to fetch data from a register associated with another processing element spaced along the string from the current processing element by the specified offset. In this way the operation of Fetching the vector operand can be executed in the minimum number of clock cycles, typically one, when the fetch variable is implemented on a SIM-SIMD parallel processor.

The set of fetch distances may comprise a set of non-regular fetch distances. In this way, the fetch variable provides the greatest efficiency as the fetch distances cannot be calculated efficiently by other regular methods.

The set of fetch distances may be defined in the fetch map variable as a relative set of offset values to be assigned to the active data processing elements. In this way, the active data processing elements are sequentially assigned offset values which have been specified in the fetch map variable. This is an efficient way of assigning offsets to all of the active data processing elements.

The set of fetch distances may also be defined in the fetch map variable as an absolute set of active data processing element identities from which the offset values are constructed. This enables the fetch map to be configured to be applied non-sequentially to the active set of processing elements of the parallel processor.

The fetch map variable may comprise an absolute set or relative set definition for defining data values for each of the active data processing elements, the absolute set or relative set definition being expressed as a pattern which has less elements than the total number of active data processing elements and the processing apparatus being arranged to define the absolute set or relative set by repeating the pattern until each of the active data processing elements has applied to it a value from the absolute set or relative set definition. This manner of specifying how the entire active set is to be defined with data values avoids the need for loops to be defined in the source code. Rather the single line instruction itself enables the programmer to specify a repeating pattern which is to be applied to the possibly very large number of data processing elements in an efficient but clear manner as has been shown in many examples described in this document. This is a very powerful construct which greatly improves the efficiency of the compilation of the source code.

Each of the processing elements of the parallel processor may comprises an Arithmetic Logic Unit (ALU) having a results register with high and low parts and the processing apparatus may be arranged to process a single line instruction which specifies a specific low or high part of the results register which is to be used as an operand in the single line instruction. This feature enables the programmer to specify an intermediate result of an operation as an operand before the previous result has been written to the results register. The advantage of this is that it reduces the number of clock cycles required to achieve the two instructions as a result writing stage to a results variable is completely omitted. For example, using this feature, in instruction 1 the logical ‘OR’ of two operands is carried out with the result being held in the results register of the ALU. However, the writing of the result to a variable assigned register is not carried out. In the next instruction the results register is consulted as an operand for carrying out the next instruction, obviating the need to access a variable assigned register which would have otherwise stored the result.

Each of the processing elements of the parallel processor may comprise an Arithmetic Logic Unit (ALU) having a results register with high and low parts and the processing apparatus may be arranged to process a single line instruction which specifies a specific low or high part of the results register as a results destination to store the result of the operation specified in the single line instruction. The advantage of specifying the location of the result of an operation, and that location being a local register of the ALU is that accessing the result in a subsequent instruction becomes quicker. The ability to store the result to a low or high part of the results register also gives the ability to store two results locally before any writing to a variable assigned register is required. The ALU may advantageously not even need to write to the register (non-local to the ALU) as the high and low parts of the results register may be able to be used as separate operands in a subsequent instruction.

The single line instruction may comprise an optional field and the processing apparatus may be arranged to process the single line instruction to carry out a further operation specified by the existence of the optional field, which is additional to that described in the single line instruction. Optional further operations may be so specified by the simply inclusion of an optional parameter and this represents a very efficient way of implementing an additional operation. There is a corresponding reduction in the source code size and thereby greater compilation efficiency whilst at the same time not making the syntax difficult to understand.

The optional field may specify a result location and the processing apparatus may be arranged to write the result of the operation to the result location. This is the specific example of specifying the result location as optional field.

The single line instruction is a compound instruction specifying at least two types of operation and specifying the processing elements to which the operations are to be carried out on, and the processing apparatus is arranged to process the compound instruction such that the type of operation to be executed on each processing element is determined by the specific selection of the processing elements in the single line instruction. The advantage of a compound instruction is that two types of operation can be specified in a single line instruction and the instruction can then specify which type of instruction is to be applied to which processing elements. This ability to selectively change the type of instruction to different elements within a linear array of processing elements is very powerful and leads to significant efficiencies in the compilation of the source code. An example of a compound instruction is an ADD/SUB instruction which has been described below in detail below.

The single line instruction may comprise a plurality of selection set fields and the processing apparatus may be arranged to determine the order in which the operands are to be used in the compound instruction by the selection set field in which the processing element has been selected. In this way the order in which data in operands provided on the processing elements are to be operated on by one of the given processing instructions can change depending on subset fields values. This is highly advantageous when using asymmetric operations (one's in which the order of the operands can give different results—such as SUBTRACT) and can be used to avoid negative answers being generated. Again this optimises the source code and thus the efficiency of the compiler in that additional instructions do not have to be expressed in new lines of source code.

According to another aspect of the present disclosure there is provided a method of processing source code comprising a plurality of single line instructions to implement a desired processing function, the method comprising:

i) processing a plurality of different instruction streams in parallel on a string-based non-associative SIMD (Single Instruction Multiple Data) parallel processor, the processing including: activating a plurality of data processing elements connected sequentially in a string topology each of which are arranged to be activated to take part in processing operations, and processing a plurality of specific instruction streams with a corresponding plurality of SIMD controllers, each SIMD Controller being connectable to a group of selected data processing elements of the plurality of data processing elements for processing a specific instruction stream, each group being defined dynamically during run-time by a single line instruction provided in the source code, and

ii) verifying and converting the plurality of the single line instructions into an executable set of commands for the parallel processor using a compiler, wherein the processing step comprises processing each single line instruction which specifies an active subset of the group of selected data processing elements for each SIMD controller which are to take part in an operation specified in the single line instruction.

The present disclosure also extends to an instruction set for use with a method and apparatus described above.

According to another aspect of the present disclosure there is provided an instruction set for use with a string-based SIMD (single instruction multiple data) non-associative data parallel processing architecture, the architecture comprising a plurality of processing elements arranged in a sequential string topology, each of which are arranged to be selectively and independently activated to be available to take part in a processing operation and to be individually selected for executing an instruction, the instruction set including a single line instruction specifying operands and an instruction to be carried out on the operands, wherein at least one of the operands comprises a set of processing elements selected from the group of available processing elements to be available to participate in the instruction.

The present disclosure in one of its non-limiting aspects resides in an instruction set which is designed to optimise control and operation of a string-based SIMD (single instruction multiple data) non-associative processor architecture. It is to be appreciated that a non-associative processor architecture is generally considered to be less complex and more efficient in terms of instruction processing than an associative processor architecture.

Key in one embodiment is the ability to turn on and off of PEs and PUs for participation in a particular instruction. The dynamic nature of the apparatus in processing the instructions efficiently is expressed by use of the expressive yet compact language of the source code syntax described herein.

Advantageously, one or more embodiments enables qualified instructions to be given to each PU. For example, the present invention can be used to control power dissipation across the PUs. For instance, a number of PUs could be shut down to save power or in response to low battery life signal, as would be required for example in mobile telecommunications handsets.

Another aspect of the present disclosure is that it contains specific single instructions which implement a conditional search of a plurality of processing elements for a match and implements the instruction with matched processing elements. The instruction set embodies these instructions as qualifier operators. Such conditional search and implementation instructions significantly reduce the number of instructions required and enables the non-associative processor architecture to be operated in an associative manner.

The expressiveness of the language is a particular advantage in that it is capable of expressing complex video signal processing tasks very concisely but expressively. In particular, the instruction set enables the sharing of PEs to be expressed. A key advantage is that the present disclosure also leads to more efficient compiling and requires a smaller code store.

### BRIEF DESCRIPTION OF THE DRAWINGS

FIG. 1 is a schematic block diagram showing the processing apparatus of an embodiment of the present invention together with a computing device for creating a source code program;

FIG. 2 is a schematic block diagram showing the general functional components of a compiler shown in FIG. 1;

FIG. 3 is a schematic block diagram showing the syntax structure of a Fetch Map Variable which is stored in the syntax rules in the compiler of FIG. 2;

FIG. 4 is a schematic block diagram showing the syntax structure of a ON Statement which is stored in the syntax rules in the compiler of FIG. 2;

FIG. 5 is a schematic block diagram showing the syntax structure of an AddSub Statement which is stored in the syntax rules in the compiler of FIG. 2;

FIG. 6 is a schematic block diagram showing the hierarchical syntax structure of a svOperand which is stored in the syntax rules in the compiler of FIG. 2;

FIG. 7 is a mathematical notation showing a Hadamard Transform which is used in an example

FIG. 8 is a prior art C++ source code listing for implementing the Hadamard Transform shown in FIG. 7; and

FIG. 9 is a source code listing according to the present embodiment for implementing the Hadamard Transform shown in FIG. 7.

While the specification concludes with claims defining the features of the present disclosure that are regarded as novel, it is believed that the present disclosure's teachings will be better understood from a consideration of the following description in conjunction with the figures, in which like reference numerals are carried forward. All descriptions and callouts in the Figures are hereby incorporated by this reference as if fully set forth herein.

### FURTHER DESCRIPTION

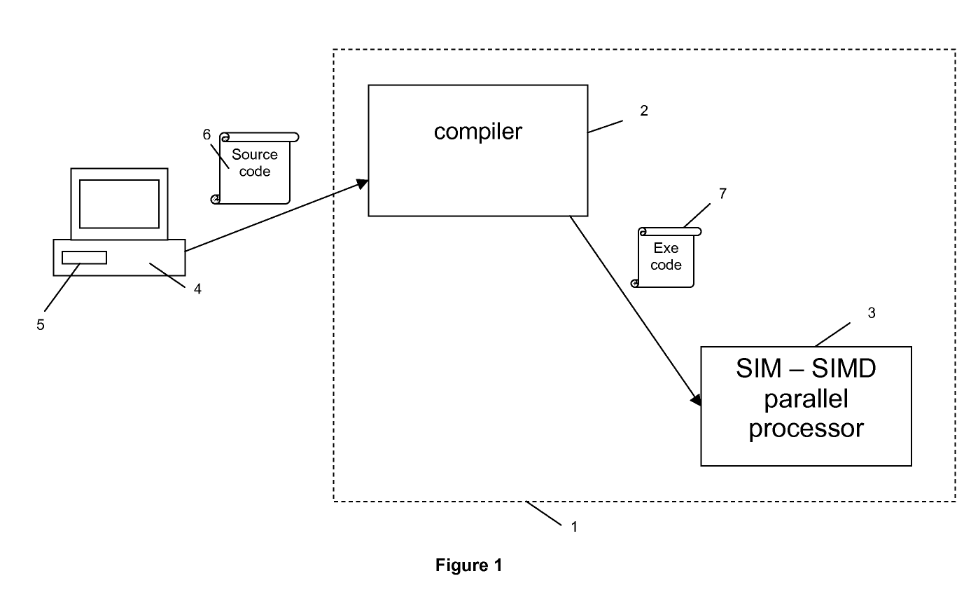

Referring to FIG. 1 there is shown a processing apparatus 1 according to an embodiment of the present invention. The function of the apparatus is to convert an input file into a form which is suitable for correct form for use on the SIM-SIMD processor 3 and then to execute the instructions on the SIM-SIMD processor 3.

The processing apparatus 1 comprises two main components, namely a compiler 2 and a SIM-SIMD parallel processor 3. The processing apparatus works in conjunction with a computing resource 4 such a PC or any computing device, which has access to a text editor 5.

In use, a programmer uses the text editor 5 on the computing resource 4 to write a program in a new high-level language for operating the SIM-SIMD parallel processor 3. This text is put into a file (a source file 6) and sent to the compiler 2 for conversion into a set of commands and instructions at a lower level a machine level which can be executed on the SIM-SIMD parallel processor 3. The output of the compiler 2 is the converted code in the form of an executable file 7 which can directly implement instructions as desired on the SIM-SIMD parallel processor 3.

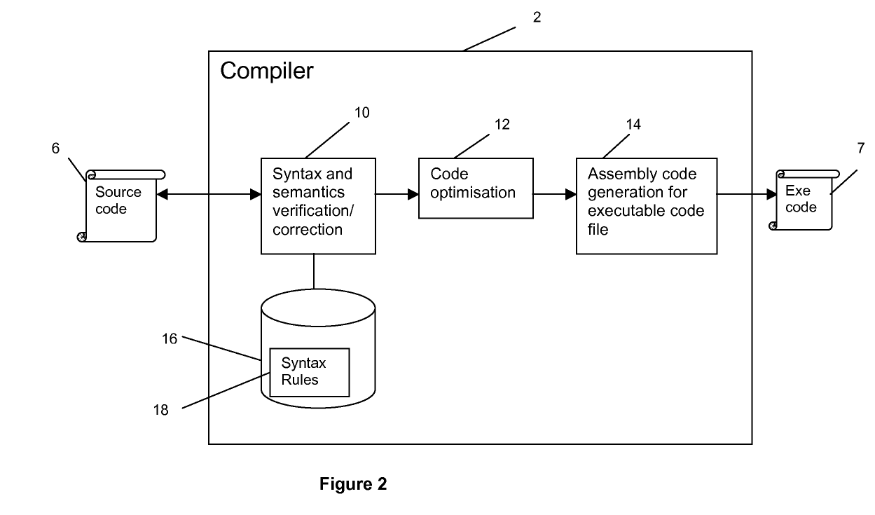

Referring now to FIG. 2, the main components of the compiler 2 are now described. Whilst the skilled person will be familiar with many known compiler structures and the techniques they employ for implementing the required functionality, an overview of the basic functionality is provided for better understanding of the present embodiment. However, it is to be appreciated that implementation of the below, described compiler will be well within the means of the skilled person from only a description of the specific syntax rules which the compiler is seeking to implement and an understanding of the SIM-SIMD parallel processor architecture which the instructions are to implemented on. Both of these are described in detail later in this document.

As can be seen in FIG. 2, the compiler comprises a syntax and semantics verification/correction module 10 which receives the source code file 6, a code optimisation module 12 and an assembly code generation module 14 for generating an executable file 7. The syntax and semantics verification/correction module 10 functions to determine whether the program in source code is correctly written in terms of the programming language syntax and semantics. If there are any errors detected, these as reported back to the programmer such that corrections can be made to the source code program. In this regard, the syntax and semantics verification/correction module 10 has access to a data store 16 which contains a set of syntax rules 18 defining the correct syntax for the programming language.

The output of the syntax and semantics verification/correction module 10 is a syntactically and semantically correct version of the source code 6 and this is passed on to the optimisation module 14. The received code is transformed into an optimised intermediate code by this module 14. Typical transformations for optimization are a) removal of useless or unreachable code, b) discovering and propagating constant values, c) relocation of computation to a less frequently executed place (e.g., out of a loop), and d) specializing a computation based on the context. The thus generated intermediate code is then passed onto the assembly code generation module 14.

The assembly code generation module 14 functions to translate the optimised intermediate code into machine code suitable for the specific SIM-SIMD processor 3. The specific machine code instructions for the SIM-SIMD parallel processor 3 are chosen for each specific intermediate code instruction. Variables are also selected for the registers of the parallel processor architecture. The output of the assembly code generation module 14 is the executable file 7.

Having briefly described the structure and function of the compiler 2, the structure of the SIM-SIMD parallel processor 3 is now described. The SIM-SIMD parallel processor employs a new parallel processor architecture which has been described in our co-pending international patent applications published as WO 2009/141654 and WO 2009/141612, the entire contents of both which are incorporated herein by reference. The relevant excerpts for WO 2009/141654 and WO 2009/141612, which are helpful in understanding of the present embodiment but whilst not strictly required as they have been referenced, are replicated in Annex 1 and Annex 2 respectively for completeness. However, the SIM-SIMD architecture is also summarised below:

### SIM-SIMD Architecture Overview

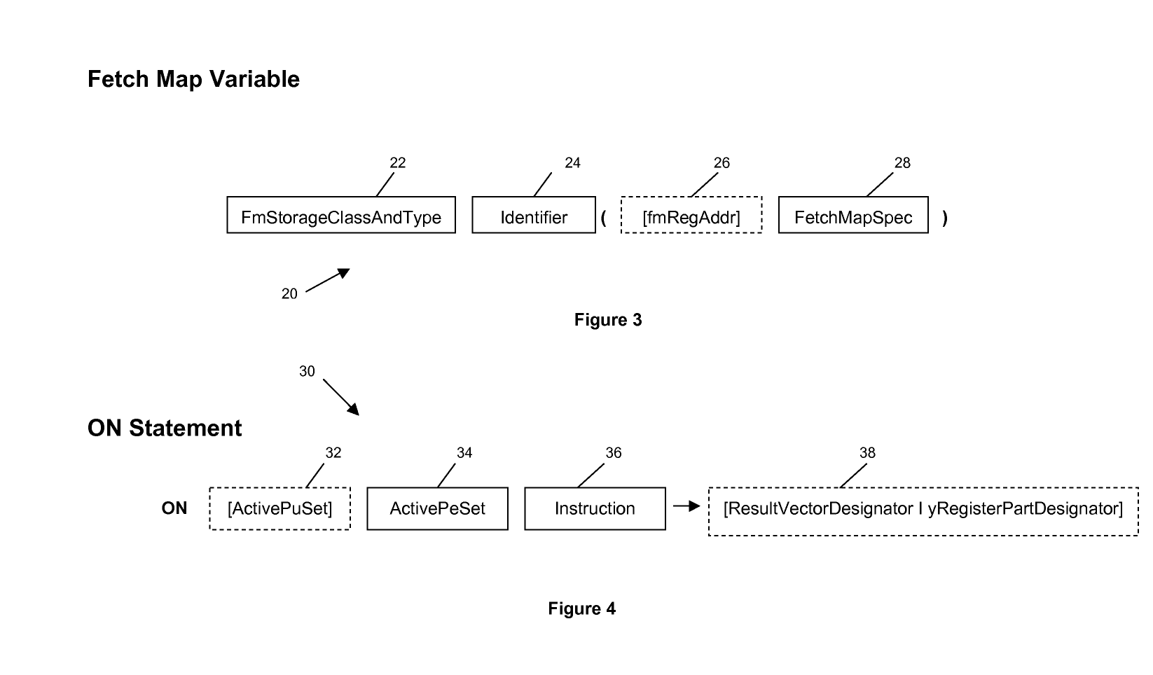

A processing unit (PU) of the new chip architecture consists of a set of sixteen 16-bit processing elements (PEs) organised in a string topology, operating in conditional SIMD mode with a fully connected mesh network for inter-processor communication. Each PE has a numerical identity and can be independently activated to participate in instructions. Identities are assigned in sequence along the string from 0 on the left to 15 on the right (see FIGS. 2 and 3 of WO 2009/141612—Annex 2).

SIMD means that all PEs execute the same instruction. Conditional SIMD means that only the currently activated sub-set of PEs execute the current instruction. The fully connected mesh network within each PU allows all PEs to concurrently fetch data from any other PE.

In addition, each PU contains a summing tree enabling sum operations to be performed over the PEs within the PU.

The inter-processor communications network allows an active PE to fetch the value of a register on a remote PE. The remote PE does not need to be activated for its register value to be fetched, but the remote register must be the same on all PEs. All active PEs may fetch data over a common distance or each active PE may locally compute the fetch distance.

The communication distance is specified within the instruction and relative to the fetching PE by an offset. A positive offset refers to a PE to the right and a negative offset to a PE to the left. The offset may be direct, i.e. the instruction contains the offset of the remote PE or it may be indirect, i.e. the instruction contains the address of the FD register within the PE that contains the offset.

A PE as expressed in the embodiment shown in WO 2009/141612 (and particularly in FIGS. 4, 5, 6 and 7—Annex 2) and in this embodiment comprises:
A 16-bit ALU, with carry and the status signals negative, zero, less and greater.
A 32-bit barrel shifter.
A 32-bit result register for storing the output from the ALU or barrel shifter.

The register is addressable as a whole (Y) or as two individual 16-bit registers (Y_{H} and Y_{L}).
A 4-bit tag register which can be loaded with the bottom 4 bits of an operation result.
A single bit flag register for conditionally storing the selected status output from the ALU and for conditionally activating the PE.
A set of 16-bit data registers, byte addressable and byte writeable.
A set of fetch distance registers containing remote PE offsets.
Operand modification logic, e.g. pre-complement, pre-shift.
Result modification logic, e.g. post-shift

Each PE is aware of the operand type (i.e. signed or unsigned). For most instructions, it will perform a signed operation if both operands are signed, otherwise it will perform an unsigned operation. For multiplication instructions, it will perform a signed operation if either operand is signed, otherwise it will perform an unsigned operation. When 8-bit data is fetched from a data register it is sign extended, according to operand type (i.e. signed or unsigned), to a 16-bit value.

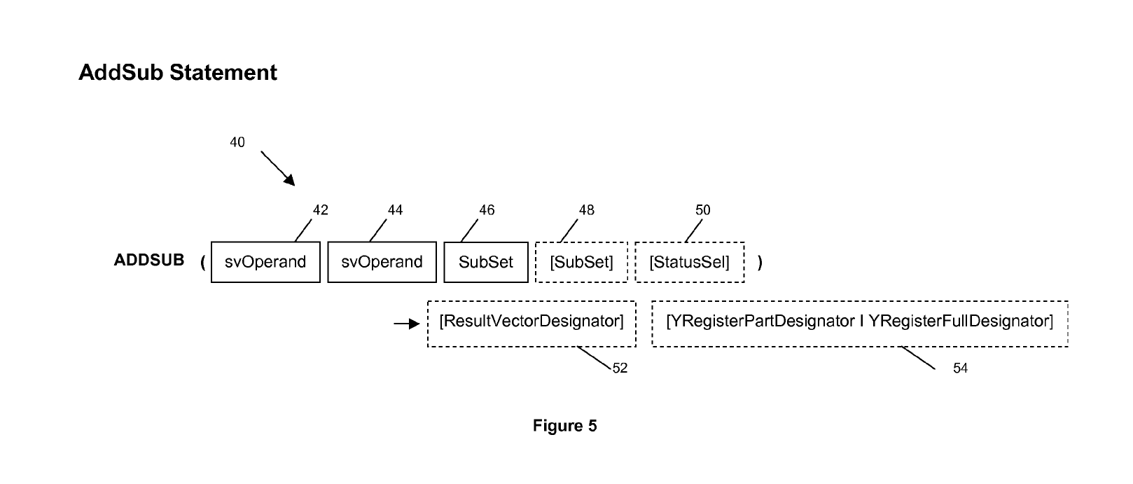

Each PE has a pipelined architecture that overlaps fetch (including remote fetch), calculation and store. It has bypass paths (shown in FIG. 5 of WO 2009/141612—Annex 2) allowing a Y register result to be used in the next instruction before it has been stored in the results register, even when on a remote PE.

The PUs can be grouped and operated by a common controller in SIM-SIMD mode. In order to facilitate such dynamic grouping, each PU has a numeric identity. PU identities are assigned in sequence along the string from 0 on the left (see FIGS. 3a to 4 of WO 2009/141654—Annex 1). SIM-SIMD means that all PUs within a group execute the same instruction, but different groups can operate different instructions. Conditional SIM-SIMD means that only the currently activated sub-set of PUs within a group execute the same current instruction.

The inter-processor communications networks of adjacent PUs can be connected giving a logical network connecting the PEs of all PUs, but not in a fully connected mesh. This means the network can be segmented to isolate each PU (see FIGS. 1 and 2 of WO 2009/141612—Annex 2).

### Control of the SIM-SIMD Parallel Processor Architecture

The ability to control the dynamic configuration of the parallel processor in order to implement different tasks on different groups of PUs is an important objective of programmer. There is further functionality which exploits the architecture of the SIM-SIMD parallel processor which is advantageously possible. All of this is facilitated by use of a new programming language (or set of high-level processing commands) to implement the required functionality, which is described and explained both generally and more specifically (later) below. This new language (instruction set) has a compact single line structure which is described below. The correct syntax of the language is reflected in the set of rules 18 which are stored in the compiler data store 16.

The set of active PUs is defined as the intersection of the global set of active PUs and the set specified explicitly within each instruction, i.e. a PU is activated if the following is true:
(PU IN GlobalActPuSet)*(PU IN ActPuSet)

Where
GlobalActPuSet is the set global of PUs to activate (under the control of one SIMD controller).
ActPuSet is the set of PUs within the global set to activate, specified by the instruction to the SIMD controller.

The following sections define the basic PU instruction set in greater detail.

### Vector and Fetch Map Variable Definitions

Definition syntax set out below is described using restricted EBNF (Extended Backus-Naur Form) notation. This syntax describes technically the language used to control a SIMD parallel processor and in particular the new SIM-SIMD parallel processor 3 described in our co-pending International patent applications mentioned above and annexed hereto.

### Vector Variable

VectorVariableDefinition=vvStorageClassAndType Identifier [“(” dRegAddr “)”]“;”

The above defines a signed or unsigned integer vector (one definitional array) containing one element for each PE. Each element of the array may be the word size of the PE (e.g. 16 bits) or 8 bits in size. The vector is not and cannot be initialised. The instruction ‘Load’ is used to initialise a vector variable.

Vector variables are stored in a set of PE data registers (see FIGS. 4 and 5 of WO 2009/141612—Annex 2). Each vector variable is distributed such that each element is on the corresponding PE and all elements use the same register on each PE.

The register is allocated and de-allocated from the limited number available automatically. The allocation processes can be overridden by specifying a register byte address in the definition. It is possible using the programming language to allocate manually an already allocated register. No warning or error is generated in this situation. A manually allocated register is not available for subsequent automatic allocation until it is freed.

8-bit vector variables are allocated on D8 boundaries. 16-bit vector variables are allocated on D16 boundaries. Attempting to manually allocate a 16-bit vector variable at an unaligned address results in the register being allocated at the next lower aligned address. No warning or error is generated in this situation.

A vector variable can also overlay an existing variable even if they are of different sizes. To do this, the name of the variable to be overlaid is specified in the definition (within the instruction). In this case, the register set is not de-allocated while any variable is mapped to it.

issVectorVariableDefinition=vvStorageClassAndType Identifier “(” [dRegAddr “,”] quoted string “);”

The above instruction is a special definition syntax supported by an instruction set simulator that permits a string to be associated with the vector variable for debugging purposes.
vvStorageClassAndType=VectorVariableIntegerType|
VectorVariableUnsignedIntegerType|VectorVariable8BitIntegerType|
VectorVariable8BitUnsignedIntegerType
VectorVariableIntegerType=“peInt”
VectorVariableUnsignedIntegerType=“peUint”
VectorVariable8BitIntegerType=“peInt8_t”
VectorVariable8BitUnsignedIntegerType=“peUint8_t”
dRegAddr=ScalarExpression|ScalarDesignator|DataRegisterDesignator “.RegAddr( )”
Identifier=??A variable name.??

### Fetch Map Variable

The structure of the Fetch Map variable 20 is illustrated in FIG. 3 and is as set out below:
FetchMapVariableDefinition=fmStorageClassAndType Identifier “(” [fmRegAddr “,”] FetchMapSpec “);”

The Fetch Map variable is a special class of vector variable worthy of its own definition. It defines and initialises an unsigned integer vector (one definitional array) containing one element for each PE. Each element contains a relative fetch offset to be used by the corresponding PE.

Fetch Map variables are stored in a limited set of multi-element fetch map registers. These registers are allocated and de-allocated automatically. The allocation processes can be overridden by specifying a register address in the definition within the instruction. It is possible to allocate manually an already allocated register. No warning or error is generated in this situation. A manually allocated register is not available for subsequent automatic allocation until it is freed.

A Fetch Map is a non-regular fetch distance (offset) of PEs required to obtain desired data, typically an operand and is used when determining where to fetch data from. The Fetch Map is typically computed and sent to the PE for using in implementing the instruction execution (namely operand fetching). All active PEs may fetch data over a common distance or each active PE may locally compute the fetch distance and fetch the operand from an irregular mapping (the Fetch Map).

The Fetch Map variable defines and initialises a one-dimensional array containing one element for each PE. Each element contains the relative fetch offset to be used by the corresponding PE. If the values in the Fetch Map are the same, then this equates to a regular fetch communication instruction. However, if the offsets are different then the communications of the different PEs are irregular fetch communication instructions. The Fetch Map determines in a simple way a host of irregular operand fetch instructions for the communications circuit 52.

More specifically, referring to FIG. 3, the Fetch Map variable comprises four arguments. The first argument is the fmStorageClassAndType variable 22 which defines the type of variable being described and is defined as:
fmStorageClassAndType=“peFMapSet”

The second argument is an identifier 24 which has been defined in the general vector variable definition above and is simply a name given to the particular fetch map, for example ‘Butterfly’.

The third optional argument is the Fetchmap Address (fmRegAddr) 26 which can be in the form of a Scalar expression or a Scalar Designator:
fmRegAddr=ScalarExpression|ScalarDesignator

The fourth argument is the fetch map specification (FetchMapSpec) 28, which defines the Fetch map. A fetch map variable is initialised according to the fetch map specification 28 part of its definition. This specification can be one of two possible types namely relative or absolute.
FetchMapSpec=RelativeFetchMapSpec|AbsoluteFetchMapSpec

A relative specification is a list of fetch offsets, where the first offset corresponds to PE 0, the second offset corresponds to PE 1 and so on. If there fewer offsets in the lists than there are PEs, the pattern that has been supplied is repeated as many times as necessary. For example peFMapSet RelMap(fmRel,1,−1) initialises the odd elements of the Fetch Map to 1 and the even elements to −1.
RelativeFetchMapSpec=“fmRel” “,” FetchOffsetList

The fetchOffsetList can be a list of direct fetch offsets.
FetchOffsetList=DirectFetchOffset {“,” DirectFetchOffset}

An absolute fetch map specification is a list of PE identities from which the fetch offsets are constructed such that PE 0 will fetch data from the PE specified by the first ID, PE 1 will fetch data from the PE specified by the second ID and so on.
AbsoluteFetchMapSpec=“fmAbs” “,” FetchPeList

The way in which the PEs in the list are stated is by listing their individual identities, namely:
FetchPeList=peIdentity{“,” peIdentity}

If there fewer PE identities than there are PEs, the pattern that has been supplied is repeated as many times as necessary, offset by the repeat stride. For example: peFMapSet AbsMap (fmAbs,3,2,1,0) specifies a reverse order map that repeats for each group of 4 PEs, i.e. it is equivalent to peFMapSet AbsMap(fmAbs,3,2,1,0,7,6,5,4,11,10,9,8,15,14,13,12).

Below is a special definition syntax supported by an instruction set simulator which is used for testing that permits a string ‘quoted string’ to be associated with the fetch map variable for debugging purposes.
FetchMapVariableDefinition=fmStorageClassAndType Identifier “(” [fmRegAddr “,”] quoted string “,” FetchMapSpec “);”
   puEnable Statement
   puEnable(ActivePuSet)

The puEnable statement set out above, specifies the global set of active PUs enabled for all subsequently executed instructions. The initial value of the global set is enable all PUs. The PU set enabled for an instruction is the intersection of the global PU set specified by the puEnable statement and the PU set included in the instruction word.

Note: PUs disabled by the ‘puEnable Statement’ are completely shut down, which means data can't be fetched from them in a remote fetch operation.

### ON Statement

Referring now to FIG. 4, a detailed explanation of the ON statement 30 is now provided. An ON Statement is an example of a ‘single line instruction’ in source code.

The ON statement 30 is a very powerful construct in that it can be used to activate groups of PUs and groups of PEs in a single instruction. It comprises three arguments and an optional fourth argument which are set out and described below:
ON([ActivePuSet], ActivePeSet, Instruction)-->[ResultVectorDesignator|yRegisterPartDesignator]

The ON statement 30 specifies the set of active PUs and PEs for the enclosed instruction and is illustrated in FIG. 1. As each PU and PE has an identifier this is used to specify which PU and PE is in the active set. The ON statement 30 comprises three components or arguments. The first argument (ActivePuSet) 32 is optional and specifies the set of active PUs, and defaults to all PUs. The second argument (ActivePeSet) 34 specifies the set of active PEs. The third argument 36 specifies the instruction. The instruction 36 can be either a Simple Instruction or a Complex Instruction and each of these are further defined later:
Instruction=SimpleInstruction|ComplexInstruction

As has been stated previously, the PU set enabled for a particular instruction is defined as the intersection of the global enabled PU set specified by the puEnable statement and the PU set included in the specific instruction word.

There is an optional fourth argument 38 which specifies which part of the Y Register is to be stored in the Result Register (see below for details). If no Result Register is specified, the write phase of the instruction is not performed.

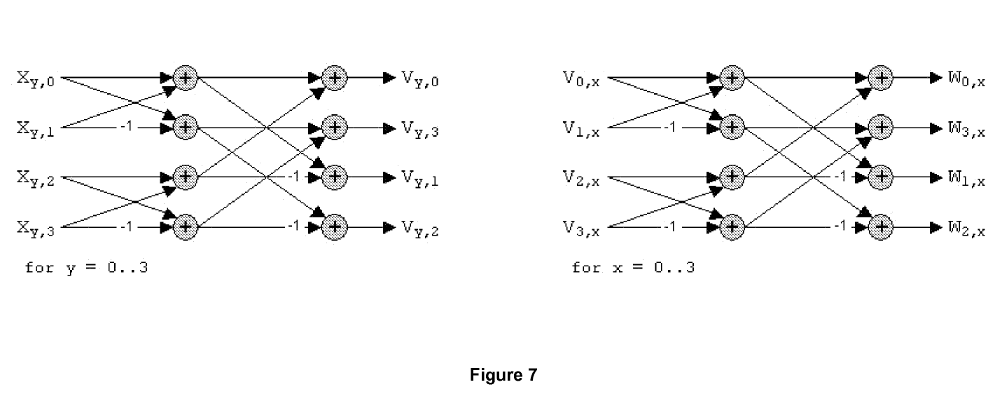

The instruction executes in parallel on all PEs within a group of PUs assigned to the same SIMD controller, but only the active set of PEs store the result in the high or low part of the Y Register, write it to the Result Register, and automatically update the Flag Register (see FIGS. 5 and 7 of WO 2009/141612—Annex 2).

As has been mentioned above, it is possible using the fourth argument 38 of the ON statement 30 to specify that the result is to comprise the data currently stored in a particular part of the Y Register. The advantage of this is that the programmer can then reduce the number of clock cycles required to implement sequential instructions where the output of one instruction becomes the operand of another following instruction. This is because there is no need to write the result of the first operation to a general purpose register which has been assigned to the result variable, but rather simply use the ALU local register as an operand for the next instruction. Also the ability to specify a high or low byte of the result register as the location of the result enables two results to be stored locally in the ALU register such that they can be used in a subsequent instruction as operands without needing to write them to the general purpose registered which have been assigned to the result variable.
ResultVectorDesignator=yRegisterPartDesignator

This fourth argument 38 can be understood to be: ‘On the active set of PEs, write the Y Register part specified by the first parameter to the Result Register.’

The ActivePeSet parameter 34 of the above On Statement 30 is now described:
ActivePeSet=UnconditionalActiveSet|ConditionalActiveSet

An active set parameter accepts a conditional or unconditional active set constructor. Each is now described in greater detail below:

### Unconditional Active Set:

UnconditionalActiveSet=“as(” (peIdentityList ActivationPattern) “)”

An unconditional active set constructor builds a set from a list of PE identifiers and identity ranges. For example as (1, 5 TO 9, 12) constructs a PE set containing PE elements with identities 1,5,6,7,8,9 and 12.

An unconditional active set constructor can also build a set from a string representation. First, all space characters are removed from the string. Then, each ‘1’, ‘A’, or ‘a’ character in the string causes the corresponding PE identifier to be included in the set, where the first character in the stripped string corresponds to PE 0, the second character corresponds to PE 1 and so on. If the stripped string contains fewer characters than there is PEs, the pattern that has been supplied is repeated as many times as necessary. If it contains more characters than there are PEs, the excess characters are ignored. If the stripped string contains no characters, an empty set is constructed. For example:
as(“1000 0000 0000 0001”) constructs a PE set containing elements 0 and 15.
as(“A . . . A”) constructs a PE set containing elements 0,3,4,7,8,11,12, and 15 (repeating pattern of four with the first and fourth being selected).

The list of PEs is defined as follows:
peIdentityList=peIdentityOrRange {“,” PeIdentityOrRange}

where
peIdentityOrRange=peIdentity|peRange

and
peRange=peIdentity “TO” peIdentity
peIdentity=??Number in the range [0 . . . implementation defined].??
ActivationPattern=??A quoted string.??

### Conditional Active Set:

This is defined as:
ConditionalActiveSet=UnconditionalActiveSet ActiveSetQualifier {ActiveSetQualifier}

Where
ActiveSetQualifier=ActiveSetFlagQualifier|ActiveSetTagQualifier

And
ActiveSetFlagQualifier =[“.F( )”|“.NF( )”]

An unconditional active set constructor can be qualified with state of the PE Flag register (“.F( )”) or its complement (“.NF( )”) to create a conditional active set. A PE is included in a conditional active set if it is in the unconditional set and its F flag is in the specified state.

Alternatively, the unconditional active set constructor can be qualified with state of the PE Tag register. The state can be defined as a TagValue and a TagMask or a Pattern as defined below:
ActiveSetTagQualifier=[“.T(” TagValue [“,” TagMask] “)”|“.T(” TerneryPattern “)”]
TagValue=??A 4 bit scalar value.??
TagMask=??A 4 bit scalar value.??
TerneryPattern=??A 4 character quoted string containing only 0s, 1s, and [x|X]s where [x|X]s represent don't-care bits.??

The ActivePuSet parameter 32 of the above On Statement 30 is now described:
ActivePuSet=UnconditionalActivePuSet

An active set parameter accepts an unconditional active set constructor, in a similar manner to that described above albeit in relation to a PE.

An unconditional active PU set constructor builds a set from a list of PU identifiers and identity ranges. For example as (1, 5 TO 9, 12) constructs a PU set containing 1,5,6,7,8,9 and 12.

An unconditional active set constructor will also build a set from a string representation. First, all space characters are removed from the string. Then, each ‘1’, ‘A’, or ‘a’ character in the string causes the corresponding PU identifier to be included in the set, where the first character in the stripped string corresponds to PU 0, the second character corresponds to PU 1 and so on. If the stripped string contains fewer characters than there is PUs, the pattern that has been supplied is repeated as many times as necessary. If it contains more characters than there is PUs, the excess characters are ignored. If the stripped string contains no characters, an empty set is constructed.

For example:
as (“1000 0000 0000 0001”) constructs a PU set containing PUs 0 and 15.

While as (“A . . . A”) constructs a PU set containing PUs 0,3,4,7,8,11,12, and 15 (repeating pattern of four with the first and fourth being selected).

UnconditionalActivePuSet=UnconditionalActiveSet ??where all references to PE identity should be read at PU identity??

In the instruction argument 38 of the ON Statement 30, two categories of instructions can be specified namely Simple Instructions and Complex Instructions. These are described below:

Simple instructions execute in one clock cycle. Simple logical instructions are covered by this but also a new class of compound instructions which are particularly concise and intuitive but also very powerful. Complex instructions conversely, execute in multiple clock cycles.

Examples of the simple instructions supported by the present embodiment and which are reflected in the syntax rules 18 are set out below:

### Copy Statement

Copy(svOperand, [StatusSel])-->[ResultVectorDesignator], [yRegisterPartDesignator]

This statement means: on the active set of PEs, store the value specified by the first parameter in the high or low part of the Y register, write it to the result register, and update the Flag register. The complement and absolute modifiers (see later under svOperands section) may not be simultaneously applied to the operand.

The second optional parameter [StatusSel] specifies the ALU status signal to be stored in the Flag register; if no signal is specified the register is not updated.

The result 2-tuple the instruction is optionally assigned to, optionally specifies the Y and result registers. If no result 2-tuple is specified, the store and write phases of the instruction are not performed. If the result 2-tuple does not specify a Y register then the lower part of the Y register is assumed. If the result 2-tuple does not specify a result register the write phase of the instruction is not performed. This is an example of how omission of an optional field from the source code instruction prevents an optional additional operation from being performed.

Note: tuples are directly implemented as product types in most functional programming languages. More commonly, they are implemented as record types, where the components are labeled instead of being identified by position alone.

### Neg Statement

Neg(svOperand, [StatusSel])-->[ResultVectorDesignator], [yRegisterPartDesignator]

This statement means: calculate the two's complement of the value specified by the first parameter. Then, on the active set of PEs, store the result in the high or low part of the Y register, write it to the result register, and update the Flag register. The complement and absolute modifiers may not be applied to the operands.

The second optional parameter specifies the ALU status signal to be stored in the Flag register; if no signal is specified the register is not updated. The result 2-tuple the instruction is assigned to, specifies the Y and result registers. If no result 2-tuple is specified the store and write phases of the instruction are not performed. If the result 2-tuple does not specify a Y register then the lower part of the Y register is assumed. If the result 2-tuple does not specify a result register the write phase of the instruction is not performed.

### NegEx Statement

NegEx(svOperand, [StatusSel])-->[ResultVectorDesignator], [yRegisterPartDesignator]

This statement means: calculate the two's complement of the value specified by the first parameter and subtract the borrow output from the previous instruction. Then, on the active set of PEs, store the result in the high or low part of the Y register, write it to the result register, and update the Flag register. The complement and absolute modifiers may not be applied to the operands.

The second optional parameter [StatusSel] specifies the ALU status signal to be stored in the Flag register; if no signal is specified the register is not updated.

The result 2-tuple the instruction is assigned to optionally specifies the Y and result registers. If no result 2-tuple is specified the store and write phases of the instruction are not performed. If the result 2-tuple does not specify a Y register the then lower part is assumed. If the result 2-tuple does not specify a result register the write phase of the instruction is not performed.

### Abs Statement

Abs(VectorOperand, [StatusSel])-->[Res ultVectorDesignator], [yRegisterPartDesignator]

This statement means: calculate the absolute value of the value specified by the first parameter. Then, on the active set of PEs, store the result in the high or low part of the Y register, write it to the result register, and update the Flag register. The complement and absolute modifiers may not be applied to the operands.

The second optional parameter [StatusSel] specifies the ALU status signal to be stored in the Flag register; if no signal is specified the register is not updated.

The result 2-tuple the instruction is assigned to optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

### Add Statement

Add(svOperand, svOperand, [StatusSel])-->[ResultVectorDesignator], [yRegisterPartDesignator]|[yRegisterFullDesignator]

This statement means: add to the value specified by the first parameter the value specified by the second parameter. If the either operand is the symbolic literal yFull a 32-bit addition is performed, otherwise a 16-bit addition is performed. Only one operand may specify a register on a remote PE and only one operand may specify a scalar value. The complement modifier may not be applied to the operands. When only one of the operands is the full Y register (symbolic literal yFull) a modifier may not be applied to it and the other operand may not be a scalar value. The full Y register on a remote PE may not be specified.

If a 32-bit operation was performed then, on the active set of PEs, store the result in the Y register and update the Flag register. Use a Y register assignment statement to write the high or low part of the Y register to the result register (if required).

If a 16-bit operation was performed then, on the active set of PEs, store the result in the high or low part of the Y register, write it to the result register, and update the Flag register.

The third optional parameter [StatusSel] specifies the ALU status signal to be stored in the Flag register; if no signal is specified the register is not updated.

The result 2-tuple the instruction is assigned to optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

### AddEx Statement

AddEx(svOperand, svOperand, [StatusSel])-->[ResultVectorDesignator], [yRegisterPartDesignator]

This statement means: add to the value specified by the first parameter the value specified by the second parameter and the carry output from the previous instruction. Then, on the active set of PEs, store the result in the high or low part of the Y register, write it to the result register, and update the Flag register. Only one operand may specify a register on a remote PE and only one operand may specify a scalar value. The complement and absolute modifiers may not be applied to the operands.

The third optional parameter [StatusSel] specifies the ALU status signal to be stored in the Flag register; if no signal is specified the register is not updated.

The result 2-tuple the instruction is assigned to optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

### Sub Statement

Sub(svOperand, svOperand, [StatusSel])-->[ResultVectorDesignator], [yRegisterPartDesignator]|[yRegisterFullDesignator]

This statement means: subtract from the value specified by the first parameter the value specified by the second parameter. If the either operand is the symbolic literal yFull a 32-bit subtraction is performed, otherwise a 16-bit subtraction is performed. Only one operand may specify a register on a remote PE and only one operand may specify a scalar value. The complement modifier may not be applied to the operands. When only one of the operands is the full Y register (symbolic literal yFull) a modifier may not be applied to it and the other operand may not be a scalar value. The full Y register on a remote PE may not be specified.

If a 32-bit operation was performed then, on the active set of PEs, store the result in the Y register and update the Flag register. Use a Y register assignment statement to write the high or low part of the Y register to the result register (if required).

If a 16-bit operation was performed then, on the active set of PEs, store the result in the high or low part of the Y register, write it to the result register, and update the Flag register.

The third optional parameter [StatusSel] specifies the ALU status signal to be stored in the Flag register; if no signal is specified the register is not updated.

The result 2-tuple the instruction is assigned to, optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

### SubEx Statement

SubEx(svOperand, svOperand, [StatusSel])-->[ResultVectorDesignator], [yRegisterPartDesignator]

This statement means: subtract from the value specified by the first parameter the value specified by the second parameter and the borrow output from the previous instruction. Then, on the active set of PEs, store the result in the high or low part of the Y register, write it to the result register, and update the Flag register. Only one operand may specify a register on a remote PE and only one operand may specify a scalar value. The complement and absolute modifiers may not be applied to the operands.

The third optional parameter [StatusSel] specifies the ALU status signal to be stored in the Flag register; if no signal is specified the register is not updated.

The result 2-tuple the instruction is assigned to, optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

### AddSub Statement

AddSub(svOperand, svOperand, SubSet, [SubSet], [StatusSel])-->[ResultVectorDesignator], [yRegisterPartDesignator]|[yRegisterFullDesignator]

This is one of the two examples of a compound instruction in the group of simple instructions. This class of statement is also shown in FIG. 5 and is described below.

This compound instruction statement 40 has a first operand field 42 and a second operand field 44. Following this there is one compulsory subset field 46 and one optional field 48 specifying the active sets of elements. An optional status select field 50 for indicating the status of the ALU is also provided. Finally results fields 52, 54 may also be specified in the optional sixth field 52, 54 as a results 2-tuple which specifies the Y and result registers.

The unique characteristic of this instruction is its ability to within a single instruction to provide different operations on the operands for each of the different processing elements as is described below. Control of which operation is to be carried out is determined by the selection sets of another operand. The key advantage of the compound instruction is that it tells the compiler specifically what aspects of the compound instruction can be carried out in parallel by different parts of the parallel processor such that the function of the single line instruction is implemented in a single clock cycle. As a result, the compiler 2 need not specifically be set up to try to discover such non-overlapping functionality, thereby reducing the burden on the compiler 2.

This statement means: perform either an addition or a subtraction using the values specified by the first and second parameters. If either operand is the symbolic literal yFull a 32-bit addition or a subtraction is performed, otherwise a 16-bit addition or a subtraction is performed. Only one operand may specify a register on a remote PE and only one operand may specify a scalar value. No modifiers may be applied to the operands. When only one of the operands is the full Y register (symbolic literal yFull) the other operand may not be a scalar value. The full Y register on a remote PE may not be specified.

If a 32-bit operation was performed then, on the active set of PEs, store the result in the Y register and update the Flag register. Use a Y register assignment statement to write the high or low part of the Y register to the result register (if required).

If a 16-bit operation was performed then, on the active set of PEs, store the result in the high or low part of the Y register, write it to the result register, and update the Flag register.

The choice of operation is made separately for each PE and is controlled by the subtraction sets specified by the third and fourth parameters 46, 48. If the PE identity is not included in either set, that PE ADDs the operands. If the PE identity is included in the first set, that PE SUBTRACTs operand two from operand one. If the PE identity is included in the second set, that PE SUBTRACTs operand one from operand two. A PE identity may not be included in both subtraction sets. The default value for the optional fourth parameter 48 is an empty set.

The optional fifth parameter 50 specifies the ALU status signal to be stored in the Flag register; if no signal is specified the register is not updated.

The result 2-tuple the instruction is assigned to, optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

### AddSubEx Statement

AddSubEx(svOperand, svOperand, SubSet, [SubSet], [StatusSel])-->[ResultVectorDesignator], [yRegisterPartDesignator]

This is the other of the two examples of a compound instruction 40 in the group of simple instructions. This class of statement is also shown in FIG. 5 and is described below.

This statement means: perform either an addition or a subtraction using the values specified by the first and second parameters 42, 44 and the carry/borrow output from the previous instruction. Then, on the active set of PEs, store the result in the high or low part of the Y register, write it to the Result register, and update the Flag register. Only one operand may specify a register on a remote PE and only one operand may specify a scalar value. No modifiers may be applied to the operands.

The choice of operation is made separately for each PE and is controlled by the subtraction sets specified by the third and fourth parameters 46, 48. If the PE identity is not included in either set, that PE ADDs the operands and carry. If the PE identity is included in the first set, that PE SUBTRACTs operand two and the borrow from operand one. If the PE identity is included in the second set, that PE SUBTRACTs operand one and the borrow from operand two. A PE identity may not be included in both subtraction sets. The default value for the fourth parameter 48 is an empty set.

Parameter five 50 specifies the ALU status signal to be stored in the Flag register; if no signal is specified the register is not updated.

The result 2-tuple the instruction is assigned to specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

### And Statement

And(svOperand, svOperand, [StatusSel])-->[ResultVectorDesignator], [yRegisterPartDesignator]

This statement means: Bitwise-AND the value specified by the first parameter with the value specified by the second parameter. Then, on the active set of PEs, store the result in the high or low part of the Y register, write it to the result register, and update the Flag register. Only one operand may specify a register on a remote PE and only one operand may specify a scalar value. The absolute modifier may not be applied to the operands.

The third optional parameter [StatusSel] specifies the ALU status signal to be stored in the Flag register; if no signal is specified the register is not updated.

The result 2-tuple the instruction is assigned to optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

By complementing one or both operands, other logical operations may be performed.

### Or Statement

Or(svOperand, svOperand, [StatusSel])-->[ResultVectorDesignator], [yRegisterPartDesignator]

This statement means: Bitwise-OR the value specified by the first parameter with the value specified by the second parameter. Then, on the active set of PEs, store the result in the high or low part of the Y register, write it to the result register, and update the Flag register. Only one operand may specify a register on a remote PE and only one operand may specify a scalar value. The absolute modifier may not be applied to the operands.

The optional third parameter [StatusSel] specifies the ALU status signal to be stored in the Flag register; if no signal is specified the register is not updated.

The result 2-tuple the instruction is assigned to, optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

By complementing one or both operands, other logical operations may be performed.

### XOR Statement

Xor(svOperand, svOperand, [StatusSel])-->[ResultVectorDesignator], [yRegisterPartDesignator]

This statement means: Bitwise-XOR the value specified by the first parameter with the value specified by the second parameter. Then, on the active set of PEs, store the result in the high or low part of the Y register, write it to the result register, and update the Flag register. Only one operand may specify a register on a remote PE and only one operand may specify a scalar value. The absolute modifier may not be applied to the operands.

The optional third parameter [StatusSel] specifies the ALU status signal to be stored in the Flag register; if no signal is specified the register is not updated.

The result 2-tuple the instruction is assigned to, optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

The result 2-tuple the instruction is assigned to, optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

By complementing one or both operands, other logical operations may be performed.

### Shift Statement

Shift(VectorOperand, svOperand, [RoundMode], [StatusSel])-->[ResultVectorDesignator], [yRegisterPartDesignator][yRegisterFullDesignator]

This statement means: shift the value specified by the first parameter left or right by the number of bits specified by the magnitude of the value specified by the second parameter (the shift distance). If the first parameter is the symbolic literal yFull a 32-bit shift is performed, otherwise a 16-bit shift is performed. Only the first operand may specify a register on a remote PE and only the second operand may specify a scalar value. The pre-shift modifier may not be applied to the first operand. No modifiers may be applied to the second operand. The absolute modifier may not be applied to the operands.

If a 32-bit shift was performed then, on the active set of PEs, store the result in the Y register and update the Flag register. Use a Y register assignment statement to write the high or low part of the Y register to the result register (if required).

If a 16-bit shift was performed then, on the active set of PEs, store the result in the high or low part of the Y register, write it to the result register, and update the Flag register.

If a signed value is shifted, an arithmetic shift is performed, otherwise a logical shift is performed. If the shift distance is negative, a right shift is performed and the result is rounded as specified by the round mode, otherwise a left shift is performed. The round mode is specified by the optional third parameter; the default mode is round towards minus infinity. The alternative mode is round to nearest (not available in all candidates).

The optional fourth parameter [StatusSel] specifies the ALU status signal to be stored in the Flag register; if no signal is specified the register is not updated.

The result 2-tuple the instruction is assigned to, optionally specifies the Y and result registers. If no result 2-tuple is specified the store and write phases of the instruction are not performed. If the result 2-tuple does not specify a Y register the lower part is assumed. If the result 2-tuple does not specify a result register the write phase of the instruction is not performed.

### Sum Statement

Sum(yRegisterFullDesignator)-->[yRegisterFullDesignator]

This statement means: sum the values specified by the full Y registers (symbolic literal yFull) for all active PEs within each PU. Then, on the active set of PEs, store the result in the Y register. Use a Y register assignment statement to write the high or low part of the Y register to the result register (if required). No modifiers can be applied to the operand. This instruction only takes one clock cycle.

### Complex Instructions:

### Multiply Statement

Multiply(VectorOperand, svOperand, [MultiplierSize],[StatusSel])-->[yRegisterFullDesignator]

This statement means: multiply the value specified by the first parameter (the multiplicand) by the value specified by the second parameter (the multiplier). Then, on the active set of PEs, store the result in the Y register. Use a Y register assignment statement to write the high or low part of the Y register to the result register (if required). Only the first operand may specify a register on a remote PE and only the second operand may specify a scalar value. No modifiers may be applied to the operands.

The value of the optional third parameter [MultiplierSize] specifies the maximum number of significant bits in the multiplier; the default value is 16. This may be used to reduce the number of clock cycles taken to perform a multiply operation when the range of the multiplier values is known to occupy less than 16 bits. The multiplier values must still be sign extended (for signed values) or zero extended (for unsigned values) to the full 16 bits to ensure correct operation.

The optional fourth parameter [StatusSel] specifies the ALU status signal to be stored in the Flag register; if no signal is specified the register is not updated.

The result 2-tuple the instruction is assigned to, optionally specifies the Y register. If no result 2-tuple is specified the store phase of the instruction are not performed.

This instruction takes one clock cycle for every two bits (rounded up) of multiplier size. It takes an additional clock cycle if the multiplier is an unsigned value and the multiplier size is an even number.

### MultAcc Statement

MultAcc(VectorOperand, svOperand, [MultiplierSize],[StatusSel])-->[yRegisterFullDesignator]

This statement means: multiply the value specified by the first parameter (the multiplicand) by the value specified by the second parameter (the multiplier) and add the result to the current value in the Y register. Then, on the active set of PEs, store the result in the Y register. Use a Y register assignment statement to write the high or low part of the Y register to the result register (if required). Only the first operand may specify a register on a remote PE and only the second operand may specify a scalar value. No modifiers may be applied to the operands.

The value of the optional third parameter specifies the maximum number of significant bits in the multiplier; the default value is 16. This may be used to reduce the number of clock cycles taken to perform a multiply operation when the range of the multiplier values is known to occupy less than 16 bits. The multiplier values must still be sign extended (for signed values) or zero extended (for unsigned values) to the full 16 bits to ensure correct operation.

The optional fourth parameter [StatusSel] specifies the ALU status signal to be stored in the Flag register; if no signal is specified the register is not updated.

The result 2-tuple the instruction is assigned to, optionally specifies the Y register. If no result 2-tuple is specified the store phase of the instruction are not performed.

This instruction takes one clock cycle for every two bits (rounded up) of multiplier size. It takes an additional clock cycle if the multiplier is an unsigned value and the multiplier size is an even number.

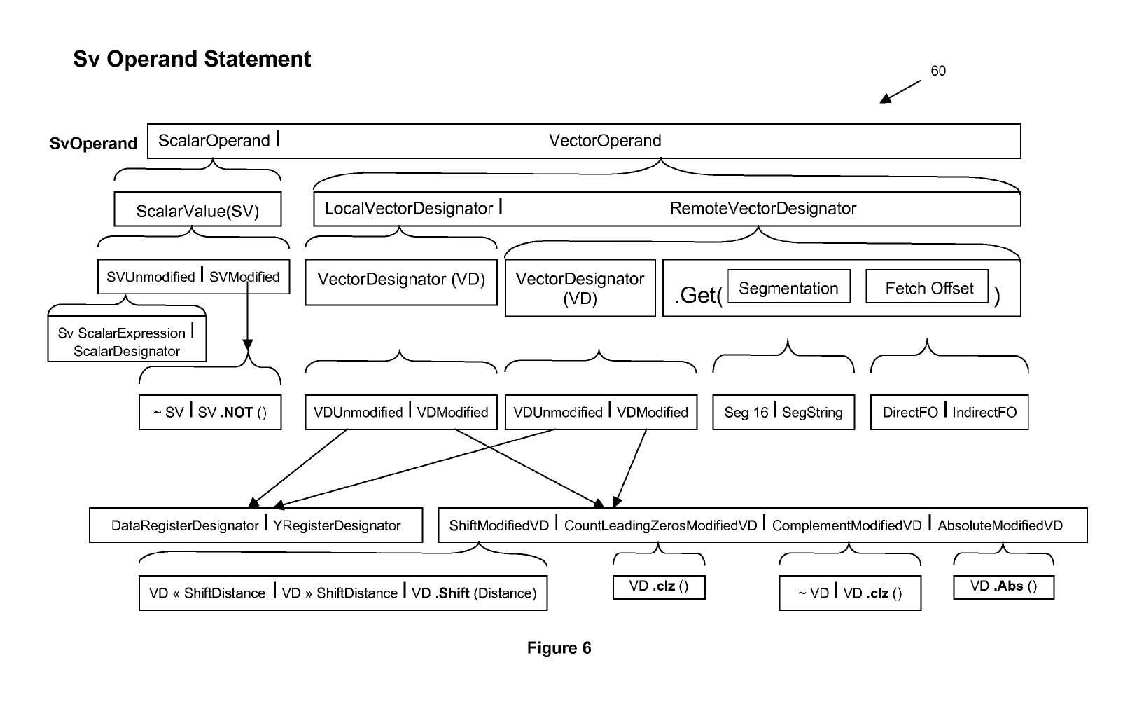

Having described the elements of the ON Statement 30, namely the ActivePuSet Parameter 32, ActivePeSet Parameter 34, and the Instruction 36, the syntax and options relating to the operands specified in the instructions are now described with reference to FIG. 6 where the hierarchical syntax structure of the svOperand is shown.

svOperand Parameter
svOperand=ScalarOperand|VectorOperand

The svOperand 60 can take the either a Scalar value or a Vector value as is seen at the highest level of the hierarchy shown in FIG. 6. Each of these optional types is further broken down as is shown in FIG. 6 and is described out below:

### VectorOperand

### VectorOperand=LocalVectorDesignator|RemoteVectorDesignator

A vector operand parameter can be either of a local vector designator or a remote vector designator. In either case, it accepts a vector variable identifier or the symbolic literals corresponding to the full Y register or its high or low part.

In the case of the remote vector designator, a fetch segmentation and offset and operand modifier may be applied to a vector operand. This is explained in greater detail below.

When a fetch segmentation and offset is applied, first the logical network connecting the PEs of all PUs is segmented into individual PUs or all PUs. Then each PE fetches the operand value from a PE the specified offset away. If the network is segmented into individual PUs wrapping takes place at the end of the each segment, otherwise values fetch from beyond the end of the string are undefined. If no segmentation is specified the default is segmented into individual PUs.

If the fetch offset is directly specified by a scalar expression, all PE use the value of this expression as the offset. If the fetch offset is indirectly specified by a fetch map variable identifier, then each PE uses the offset in the corresponding element of the fetch map.

Operand modifiers are applied to the value fetched in the order: shift, count leading zeros, absolute, complement. This circuit (barrel shifter 81 and shift circuit 92) required to implement this modification is shown in FIGS. 6 and 7 of WO 2009/141612 (ANNEX 2). The shift modifier can be used as follows so simplify source code generation:

If two operands are combined as follows: C=(A×2)+(B×4), this would conventionally be written in C++ as three lines of code:

A=A×2

B=B×4

C=A+B

In the present embodiment, this is written highly efficiently as:

C=ADD(A→1, B→2)

where → indicates a shift operation.
As shown in FIG. 6, the above many be expressed hierarchically as:
Local VectorDesignator=VectorDesignator
RemoteVectorDesignator=VectorDesignator“.Get(” [Segmentation “,”] FetchOffset “)”
VectorDesignator=VectorDesignatorUnmodified|VectorDesignatorModified
VectorDesignatorUnmodified=DataRegisterDesignator|yRegisterDesignator
DataRegisterDesignator=??The identifier of a vector variable.??
VectorDesignatorModified=ShiftModifiedVectorDesignator|
CountLeadingZerosModifiedVectorDesignator|
ComplementModifiedVectorDesignator|AbsoluteModifiedVectorDesignator
ShiftModifiedVectorDesignator=
   (VectorDesignator “<<” ShiftDistance)
   (VectorDesignator “>>” ShiftDistance)
   (VectorDesignator “.Shift(” ShiftDistance “)”)
ShiftDistance=??Integer scalar expression in the range implementation defined . . . implementation defined 1.??
CountLeadingZerosModifiedVectorDesignator=
   (VectorDesignator “.clz( )”)
ComplementModifiedVectorDesignator=
   (“˜” VectorDesignator)|
   (VectorDesignator “.Not( )”)
AbsoluteModifiedVectorDesignator=
   (VectorDesignator “.Abs( )”)
Segmentation=“Seg16”|“SegStr”
FetchOffset=DirectFetchOffset|IndirectFetchOffset
   DirectFetchOffset=??Integer scalar expression in the range [implementation defined . . . implementation defined].??
   IndirectFetchOffset=??The identifier of a fetch map variable.??

### ScalarOperand Parameter

### ScalarOperand=ScalarValue

A scalar operand parameter accepts a scalar expression or scalar variable identifier that has been converted into a scalar value. An operand modifier may be applied to a scalar operand. Modifiers are applied to the value in the order: complement.

### ScalarValue=ScalarValueUnmodified|ScalarValueModified

ScalarValueUnmodified=“(sv)” (ScalarExpression|ScalarDesignator)
ScalarExpression=??An expression whose operands are numbers or scalar variables.??
ScalarDesignator=??The identifier of a scalar variable.??

### ScalarValueModified=ComplementModifiedScalarValue

### ComplementModifiedScalarValue=

(“˜” ScalarValue)|

(ScalarValue“.Not( )”)

Other parameters referred to by the instructions are now explained and defined below:

### StatusSel Parameter

StatusSel=“ssNoOp”|“ssNegative”|“ssZero”|“ssLess”|“ssGreater”|“WriteTag”

A status select parameter accepts the symbolic literals corresponding to the ALU status signals (See Annex 2 FIG. 7 and its description) or the “no operation” symbolic literal. WriteTag is a special symbol is used to specify that the tag register should be loaded with the bottom 4 bits of the result register. WriteTag can be OR'd with the other symbols.

### RoundMode Parameter

RoundMode=“rmMInfinity”|“rmNearest”

A round mode parameter accepts the symbolic literals corresponding to the shift rounding modes.

### MultiplierSize Parameter

MultiplierSize=??nsigned integer scalar expression in the range [0 . . . implementation defined].??

A multiplier size parameter accepts a scalar expression.

### SubSet Parameter

### SubSet=UnconditionalActiveSet

A subtract set parameter accepts an unconditional active set constructor.

### Result Tuple Statement

ResultTuple=CompleteResultTuple|ImpliedResultTuple|yOnlyResultTuple

Definition syntax is described using restricted EBNF notation.

A result tuple is an ordered one or two element list of variable and Y register designators. A complete result tuple contains a variable and Y register designator. An implied result tuple only contains a variable designator, but also implies the yLow designator. Either define the vector variable and Y register the result of an instruction is assigned to. A Y register only result tuple only contains a Y register designator. It defines the Y register the result of an instruction is assigned to.

The result tuple can only appear on the left-hand side of an assignment statement.

CompleteResultTuple=ResultVectorDesignator “,” yRegisterPartDesignator

### ImpliedResultTuple=ResultVectorDesignator

yOnlyResultTuple=YRegisterDesignator

### ResultVectorDesignator=DataRegisterDesignator

yRegisterDesignator=yRegisterFullDesignator|yRegisterPartDesignator
yRegisterFullDesignator=“yFull”
yRegisterPartDesignator=“yLow”|“yHigh”

### ALU Status Parameter

The ALU status signals negative, zero, less and greater are updated by every instruction. The ALU status signals are left in an undefined state by the Multiply and MultAcc instructions and by the Shift instruction with a 32-bit operand. For the remaining instructions the following table defines the condition where the signal is set, otherwise it is cleared. The status signal is undefined for unlisted instructions. In the following table 1.

| ALU status | Operation type | | |
|---|---|---|---|
| signal | Unsigned | Signed | Instructions |
| Zero | Result = 0 | | Copy, Neg, NegEx, Abs, Add, |
| | | | AddEx, Sub, SubEx, AddSub, |
| | | | AddSubEx, And, Or, Xor, Shift(16 |
| | | | bit operand) |
| Negative | Never set | Result < 0 | Copy, Neg, NegEx, Add, AddEx, |
| | | | Sub, SubEx, AddSub, AddSubEx, |
| | | | And, Or, Xor, Shift(16 bit operand) |
| | Never set | | Abs |
| Less | Operand 1 < Operand 2 | | Sub, SubEx |
| | Never set | Operand < 0 | Abs |

| | | |
|---|---|---|
| Greater | Operand 1 > Operand 2 | Sub, SubEx |
| | Operand > 0 | Abs |

if either operand is signed, otherwise they will perform an unsigned operation. This default behaviour can be overridden by casting the type of the operands passed to the instruction or the value returned by it.

### Instruction Return Type

The type of the value returned by an instruction indicates if the signed or unsigned version was performed. When the returned value is assigned to a Y register, the dynamic type of the Y register parts is changed to the type of the value. When the returned value is assigned to a vector variable it is converted to the type of the variable. When the returned value is assigned to both the dynamic type of the Y register parts is changed and the converted value is stored in the variable. In practice, the representation of a signed and unsigned word is the same so no conversion is required.

The type of the return value can be forced to another type using the cast operator.

For extended arithmetic operations the ALU status signals are valid after the last operation extension instruction.

### Types and Casting

All instructions can perform signed or unsigned versions of their operation. Most instructions will perform a signed operation if both operands are signed, otherwise they will perform an unsigned operation. Multiplication instructions will perform a signed operation.

### “(” VectorVariableBaseType “)” Instruction

### VectorVariableBaseType=VectorVariableIntegerType

### VectorVariableUnsignedIntegerType

Note: casting (the value returned by) an instruction does not change the way it performs the operation i.e. computes the status and sets the flag register.

### Operand Type

The type of the operands passed to an instruction, controls if the signed or unsigned version was performed and what, if any, conversion of the operand takes place when they are fetched.

The type of a vector variable is fixed when it is defined and never changes. The type of a Y register part is dynamic. It is set each time the register part is assigned to. The type of each Y register part is initially undefined.

The type of an operand can be forced to another type using the cast operator.

### “(” VectorVariableType “)” VectorDesignatorUnmodified

### VectorVariableType=VectorVariableIntegerType|

### VectorVariableUnsignedIntegerType|VectorVariable8BitIntegerType|

### VectorVariable8BitUnsignedIntegerType

The cast operator must be applied to an operand before any modifiers are applied.

A Y register designator cannot be cast to a different size. A vector variable designator can be cast to a different size.

The following table 2 describes the behaviour when casting between types:

| | | Cast To | | | |
|---|---|---|---|---|---|
| | | uint_t | int8_t | uint | int |
| Cast | uint8_t | Zero extend | Sign extend | Zero | Zero |
| From | | | | extend | extend |
| | int8_t | Zero extend | Sign extend | Sign | Sign |
| | | | | extend | extend |
| | uint | Truncate then zero | Truncate then sign | | |
| | | extend | extend | | |
| | int | Truncate then zero | Truncate then sign | | |
| | | extend | extend | | |

All operands are implicitly cast to 16-bit values or the same type, i.e.
peInt8_t i8;
Copy(i8); is executed as Copy((peInt)i8);
Copy((peUint8_t)i8); is executed as Copy((peUint)(peUint8_t)i8);

Warning: Because of hardware limitations it is illegal to cast an 8-bit signed vector variable in to an 16-bit unsigned value when a pre-shift modifier will be applied, or it will be the operand of a shift instruction.

### EXAMPLES

The following examples illustrate how the current language syntax can be used to efficiently express a desired set of commands for the SIM-SIMD parallel processor 3. In each example source code instructions are provided together with text comments indicating what the source code instructions mean.

### Example 1

// Define vector variables.
// Note there is no guarantee that the registers aVar and dVar are allocated to are not being used.
peUint aVar((peRegAddress_t)0); // An unsigned integer manually allocated to register 0.
peInt bVar; // A signed integer automatically allocated.
peInt cVar(aVar.RegAddr( )); // A signed integer overlaid on aVar.
peInt dVar(6, “dVar”); // A signed integer manually allocated with a debug name.
peInt eVar(“eVar”); // A signed integer automatically allocated with a debug name.
// Add the scalar value −2 to a vector, storing the result in another vector via lower part of Y, don't update the Flag register.
bVar=Add(cVar, (sv)−2);
   // Add two vectors, storing the result in another vector via lower part of Y, don't update Flag register.
bVar=Add(cVar, dVar);
   // As above, except the high part of Y is used.
bVar, yHigh=Add(cVar, dVar);
   // As above, except the write is not performed.
yHigh=Add(cVar, dVar);
   // As above, except the Flag register is updated with the zero status signal.
yHigh=Add(cVar, dVar, ssZero);
   // As above, but only the even numbered PEs are in the active set. yHigh=ON(as(“a.”), Add(cVar, dVar, ssZero));

### Example 2

// Define a buffer of external data.

uint16_t Buffer[PES_PER_L_PU]={0,1,2,3,4,5,6,7,8,9,10,11,12,13,14,15};

// Define vector variables, with debug names
peUint aVar(“aVar”);
peInt bVar(“bVar”);
   / Define scalar variables
int aScale=100;
int bScale=2;
   // Define fetch maps.
peFMapSet Bufferfly2(fmRel,1,−1); // Eight two PE butterflies.
peFMapSet Bufferfly16(fmAbs,15,14,13,12,11,10,9,8,7,6,5,4,3,2,1,0); // A 16 PE butterfly.

peFMapSet Map1(“Map1”,fmRel,2,2,−2,−2); // Give a debug name.
peFMapSet Map2(4,fmRel,−3,−2,−1,1,2,3); // Manually allocated to register 4.
peFMapSet Map3(5,“Map3”,fmRe1,1,−1); // Give a debug name and manually allocate.
   // Load external data into a vector.
aVar.Load(Buffer);
   // OR the scalar value 100 to value fetched from the PE to the right
   // after that value is shift by two then complemented. Storing the result in the high part of
   // Y, but not writing it back to a vector.
yHigh=Or((sv)aScale, ˜aVar.Get(1)<<bScale);
   // On the even numbered PEs add the previous result to the value fetched from a remote PE
   // using a butterfly fetch pattern and write the result to a vector.
bVar=ON(as(“a.”), Add(yHigh, aVar.Get(Bufferfly16)));

// Dump vector to external data.
aVar.Dump(Buffer);

### Example 3

Referring to FIG. 7 there is graphically illustrated a Hadamard Transform in which a 2-D Fourier transform is separated into two 1-D transforms.

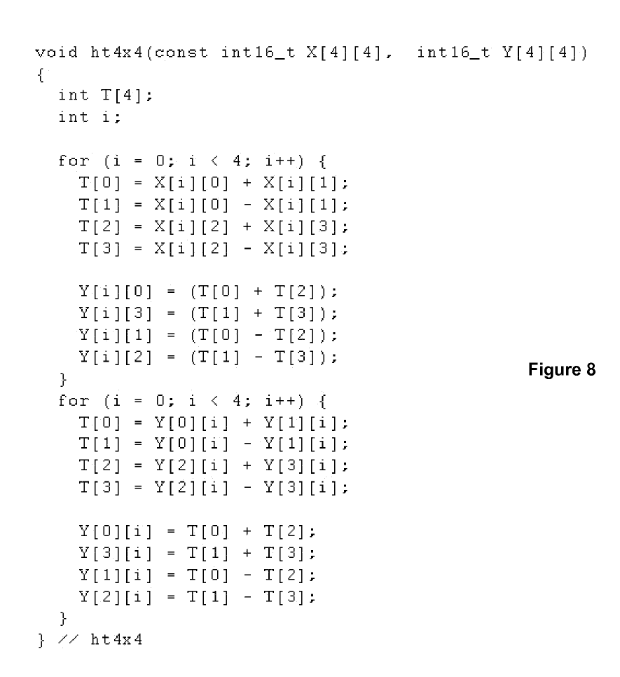

The corresponding code to perform the transform above transform when written in ‘C++’ is shown in FIG. 8. Here it can be seen that in FIG. 8 the pattern of PEs to be combined is defined by the instructions set out in the ‘for loops’. This source code would have to be interpreted by a compiler and the required instruction streams for a SIM-SIMD parallel processor determined. This is a very difficult task for any compiler and would take a great deal of time.

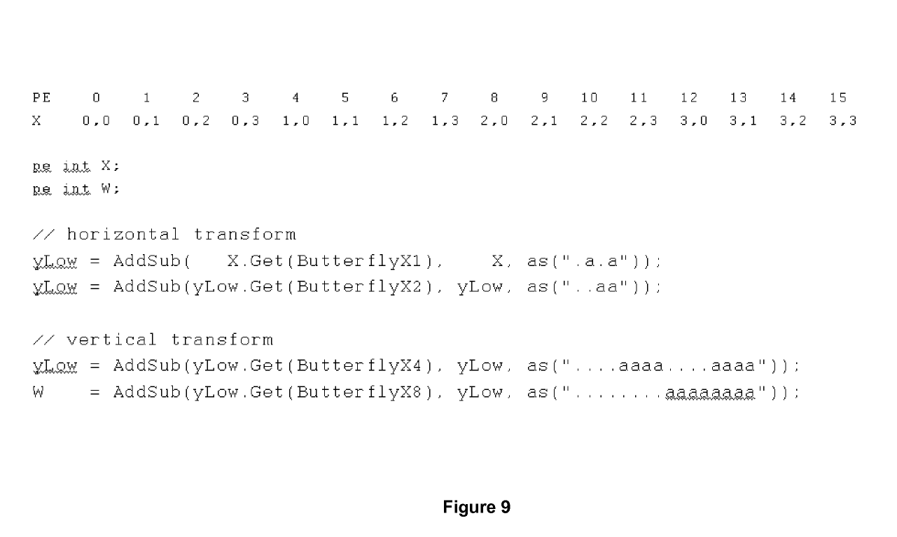

However, using the new instruction set, as shown in FIG. 9, the instruction simply calls in a parameter which specifies a particular pattern of PEs to be initiated. The use of parameters in this way makes a significant difference to the size of the instruction code. Furthermore, this source code specifies to the compiler exactly what can be carried out in parallel and what cannot and as such it makes the compiler's task far easier, thereby increasing the compilation speed.

When the source code of FIG. 8 is compared to the corresponding code of the present embodiment, shown in FIG. 9, it is clear that the present embodiment enables code to be written in an efficient and economical way allowing the programmer more expressivity. Accordingly, the apparatus of the present embodiment has a reduced size code store as compared to the known prior art.

Having described a particular preferred embodiment of the present invention, it is to be appreciated that the embodiment in question is exemplary only and that variations and modifications such as will occur to those possessed of the appropriate knowledge and skills may be made without departure from the spirit and scope of the disclosure as set forth in the appended claims.

1. A processing apparatus for processing source code comprising a plurality of single line instructions to implement a desired processing function, the processing apparatus comprising:
i) a string-based non-associative multiple—SIMD (Single Instruction Multiple Data) parallel processor arranged to process a plurality of different instruction streams in parallel, the processor including:
a plurality of data processing elements connected sequentially in a string topology and organised to operate in a multiple—SIMD configuration, the data processing elements being arranged to be selectively and independently activated to take part in processing operations, and
a plurality of SIMD controllers, each connectable to a group of selected data processing elements of the plurality of data processing elements for processing a specific instruction stream, each group being defined dynamically during run-time by a single line instruction provided in the source code, and
ii) a compiler for verifying and converting the plurality of the single line instructions into an executable set of commands for the parallel processor,
wherein the processing apparatus is arranged to process each single line instruction which specifies an operation and an active group of selected data processing elements for each SIMD controller that is to take part in the operation.

2. A processing apparatus according to claim 1, wherein the single line instruction comprises a qualifier statement and the processing apparatus is arranged to process a single line instruction to activate the group of selected data processing elements for a given operation, on condition of the qualifier statement being true.

3. A processing apparatus according to claim 2, wherein each of the processing elements of the parallel processor comprises: an Arithmetic Logic Unit (ALU); a set of Flags describing the result of the last operation performed by the ALU and a TAG register indicating least significant bits of the last operation performed by the ALU, and the qualifier statement in the single line instruction comprises either a specific condition of a Flag of an Arithmetic Logic Unit result or a Tag Value of a TAG register.

4. A processing apparatus according to any preceding claim, wherein the single line instruction comprises a subset definition statement defining a non-overlapping subset of the group of active data processing elements and the processing apparatus is arranged to process the single line instruction to activate the subset of the group of active data processing elements for a given operation.

5. A processing apparatus according to any preceding claim, wherein the single line instruction comprises a subset definition statement for defining the subset of the group of selected data processing elements, the subset definition being expressed as a pattern which has less elements than the available number of data processing elements in the group and the processing apparatus is arranged to define the subset by repeating the pattern until each of the data processing elements in the group has applied to it an active or inactive definition.

6. A processing apparatus according to any preceding claim, wherein the single line instruction comprises a group definition for defining the group of selected data processing elements, the group definition being expressed as a pattern which has less elements than the total available number of data processing elements and the processing apparatus is arranged to define the group by repeating the pattern until each of the possible data processing elements has applied to it an active or inactive definition.

7. A processing apparatus according to any preceding claim, wherein the single line instruction comprises at least one vector operand field relating to the operation to be performed, and the processing apparatus is arranged to process the vector operand field to modify the operand prior to execution of the operation thereon.

8. A processing apparatus according to claim 7, wherein the processing apparatus is arranged to modify the operand by carrying out one of the operations selected from the group comprising a shift operation, a count leading zeros operation, a complement operation and an absolute value calculation operation.

9. A processing apparatus according to any preceding claim, wherein the single line instruction specifies within its operand definition a location remote to the processing element and the processing apparatus is arranged to process the operand definition to fetch a vector operand from the remote location prior to execution of the operation thereon.

10. A processing apparatus according to any preceding claim, wherein the single line instruction comprises at least one fetch map variable in a vector operand field, the fetch map variable specifying a set of fetch distances for obtaining data for the operation to be performed by the active data processing elements, wherein each of the active data processing elements has a corresponding fetch distance specified in the fetch map variable.

11. A data processing apparatus according to claim 10, wherein the processing elements are arranged in a sequential string topology and the fetch variable specifies an offset denoting that a given processing element is to fetch data from a register associated with another processing element spaced along the string from the current processing element by the specified offset.

12. A processing apparatus according to claim 10 or 11, wherein the set of fetch distances comprises a set of non-regular fetch distances.

13. A processing apparatus according to any of claims 10 to 12, wherein the set of fetch distances are defined in the fetch map variable as a relative set of offset values to be assigned to the active data processing elements.

14. A processing apparatus according to any of claims 10 to 12, wherein the set of fetch distances are defined in the fetch map variable as an absolute set of active data processing element identities from which the offset values are constructed.

15. A processing apparatus according to any of claims 10 to 13, wherein the fetch map variable comprises an absolute set or relative set definition for defining data values for each of the active data processing elements, the absolute set or relative set definition being expressed as a pattern which has less elements than the total number of active data processing elements and the processing apparatus being arranged to define the absolute set or relative set by repeating the pattern until each of the active data processing elements has applied to it a value from the absolute set or relative set definition.

16. A processing apparatus according to any preceding claim, wherein each of the processing elements of the parallel processor comprises an Arithmetic Logic Unit (ALU) having a results register with high and low parts and the processing apparatus is arranged to process a single line instruction which specifies a specific low or high part of the results register which is to be used as an operand in the single line instruction.

17. A processing apparatus according to any preceding claim, wherein each of the processing elements of the parallel processor comprises an Arithmetic Logic Unit (ALU) having a results register with high and low parts and the processing apparatus is arranged to process a single line instruction which specifies a specific low or high part of the results register as a results destination to store the result of the operation specified in the single line instruction.

18. A processing apparatus according to any preceding claim, wherein the single line instruction comprises an optional field and the processing apparatus is arranged to process the single line instruction to carry out a further operation specified by the optional field, which is additional to that described in the single line instruction.

19. A processing apparatus according to claim 18, wherein the optional field specifies a result location and the processing apparatus is arranged to write the result of the operation to the result location.

20. A processing apparatus according to any preceding claim, wherein the single line instruction is a compound instruction specifying at least two types of operation and specifying the processing elements to which the operations are to be carried out on, and the processing apparatus is arranged to process the compound instruction such that the type of operation to be executed on each processing element is determined by the specific selection of the processing elements in the single line instruction.

21. A processing apparatus according to claim 20, wherein the single line instruction comprises a plurality of selection set fields and the processing apparatus is arranged to determine the order in which the operands are to be used in the compound instruction by the selection set field in which the processing element has been selected.

22. A method of processing source code comprising a plurality of single line instructions to implement a desired processing function, the method comprising:
i) processing a plurality of different instruction streams in parallel on a string-based non-associative SIMD (Single Instruction Multiple Data) parallel processor, the processing including:
activating a plurality of data processing elements connected sequentially in a string topology each of which are arranged to be activated to take part in processing operations, and
processing a plurality of specific instruction streams with a corresponding plurality of SIMD controllers, each SIMD Controller being connectable to a group of selected data processing elements of the plurality of data processing elements for processing a specific instruction stream, each group being defined dynamically during run-time by a single line instruction provided in the source code, and
ii) verifying and converting the plurality of the single line instructions into an executable set of commands for the parallel processor using a compiler,
wherein the processing step comprises processing each single line instruction which specifies an active subset of the group of selected data processing elements for each SIMD controller which are to take part in an operation specified in the single line instruction.

23. An instruction set for use with a method according to claim 22.
